(19) United States
(12) Patent Application Publication
(10) Pub. No.: US 2001/0042338 A1
(43) Pub. Date: Nov. 22, 2001

(54) Insect deterring support

(76) Inventor: Robert L. Jackson, Batesburg, SC (US)

Correspondence Address: MICHAEL A MANN, NEXSEN PRUET JACOBS & POLLRD LLC, P O DRWR 2426, COLUMBIA, SC, 29202-2426, US

(21) Appl. No.: 09/805,303

(22) Filed: Mar. 13, 2001

Related U.S. Application Data
(60) Provisional application No. 60/189,250, filed on Mar. 14, 2000.

(51) Int. Cl. A01M 1/10

(52) U.S. Cl. 43/121

(57) ABSTRACT

A support that prevents crawling insects from accessing the structure that is being supported. The support includes a shaft having a base at one end and a platform for holding a load at the other end. A moat is positioned on the shaft below the platform, which prevents insects from crawling further upward and thereby accessing the load being supported. A shield that is slidably received by the shaft is positioned above the moat in order to prevent particulate from entering moat.

### PRIORITY CLAIM

The inventor claims the priority benefit of the filing of U.S. provisional patent application 60/189,250, filed Mar. 14, 2000.

### FIELD OF THE INVENTION

The present invention relates to insect traps; in particular, the present invention relates to a support that prevents insects from crawling upward to a structure holding food, water or the like.

### DISCUSSION OF BACKGROUND

Insects will contaminate any food they come into contact with. When food is consumed out of doors, for example, at a picnic, the problem is especially acute. Placing the food onto a picnic table does not preclude insects from gaining access to the food; instead, the insects merely crawl up the legs of the table. In order to prevent this problem, insecticides may be sprayed on areas across which insects travel in their attempts to gain access to food on an elevated surface. Many varieties of insecticide have been created. However, these chemicals are harmful for the environment and may cause illnesses to those using them.

Therefore, there exists a need for a better way to prevent insects from crawling upward to the tabletop surface.

### SUMMARY OF THE INVENTION

According to its major aspects and broadly stated, the present invention is a support that prevents insects from accessing the surface of a structure that is being supported. The support comprises a reinforced shaft having a base at one end and a platform for holding a structure at the other end. A “moat” is formed on the shaft below the platform, which prevents insects from crawling further upward and thereby accessing the load being supported. A shield slidably received by the shaft is positioned above the moat in order to prevent particulate from falling into the moat.

A major feature of the present invention is the reinforced shaft. With this shaft reinforced with concrete, steel or other like material, the support can carry a heavy load. As a result, support could be used to support a table, chair, bench or other heavy structure.

Another important feature of the present invention is the shield. The shield reduces the amount of dirt particulate that is accumulated in the moat so that the support will require less frequent cleaning.

Other features and advantages of the present invention will be apparent to those skilled in the art from a careful reading of the Detailed Description of a Preferred Embodiment presented below and accompanied by the drawings.

### BRIEF DESCRIPTION OF THE DRAWINGS

In the drawings,

FIG. 1 is a perspective view of a support, according to a preferred embodiment of the present invention; and

FIG. 2 is a side cross-sectional view of a support along line 2-2 of FIG. 1, according to a preferred embodiment of the present invention.

### DETAILED DESCRIPTION OF A PREFERRED EMBODIMENT

Referring now to the figures, the present invention is a support that prevents insects from crawling upward to the item being supported (not shown). The support, generally referred to by reference number 10, has sufficient structural strength to carry a wide variety of loads, such as a table, chair, feeder or other relatively heavy items.

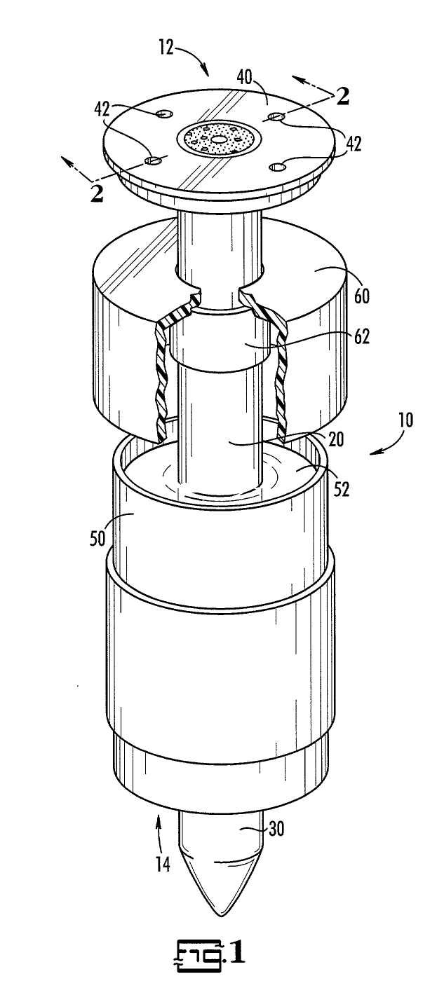

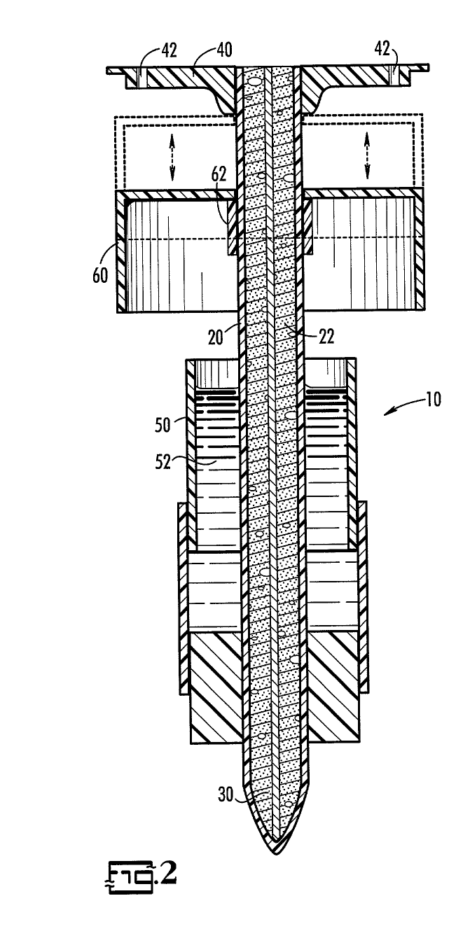

Referring to FIG. 1, support 10 comprises a shaft 20 having a top end 12 and a bottom end 14. Shaft 20 may be made of various materials, such as metal, plastic, wood or any other material having sufficient structural characteristics to support the load it is intended to be used to support, or the heaviest load it is intended to be used to support. Preferably, shaft 20 is a hollow metal or plastic cylinder with a reinforcement 22 therein, as best seen in FIG. 2. Reinforcement 22 is formed from a material capable of supporting heavy loads, such as steel, concrete or hardened plastic. Since support 10 is intended to be placed outdoors for extended periods of time, preferably shaft 20 is formed from a weather-proof material, such as PVC, aluminum or the like.

A base 30 is formed near the bottom end 14 of shaft 20 to support shaft in an upright position. Although base 30 preferably is tapered to be driven into the ground, base 30 may be of sufficient dimension to support shaft in an upright position on a relatively flat surface without penetration.

Again referring to FIG. 1, a platform 40 is attached to shaft 20 near top end 12 of support 10. Platform 40 may have various shapes depending upon the load intended to be supported. Preferably, platform 40 defines a flange for fastening support 10 to the load. Platform 40 may optionally have a plurality of attachment holes 42 formed therein so that the load may be secured using screws, bolts or the like. Platform 40 may also have other means that allows a load to be easily secured to support 10. Platform 40 may be formed from various materials, such as metal, wood or hardened plastic.

A moat 50 is attached to shaft 20 in a position below platform 40. Moat 50 defines an annular container for holding a fluid 52 or other insect-impassible substance (such as a sticky solid), which serves as a barrier to prevent insects from passing from moat 50 to shaft 20. As an insect attempts to crawl upward to reach the load that is being supported, the insect will crawl into contents 52 carried by moat 50 and go no further. Although moat 50 could carry an insecticide, preferably moat 50 contains a non-toxic substance, such as water.

A shield 60 is positioned above moat 50 and dimensioned to cover the fluid 52 of moat 50 to reduce any dirt particulate from getting into the contents of moat 50. Shield 60 rests upon stop 62 and is capable of sliding longitudinally along shaft 20 between a lowered position resting upon stop 62 and a raised position wherein shield 60 contacts the bottom of platform 40. In a lowered position shield 60 reduces the quantity of dirt particulate that falls into the contents 52 of moat 50; however, the raised position allows access to moat 50 for cleaning and replacement of fluid 52.

In use, base 30 of shaft 20 is driven into the ground so that support 10 is maintained into an upright position. A quantity of fluid 52 is placed into moat 50, so that an insects seeking to climb up to load will drown. In order to gain access to fill moat 50, shield 60 should be placed onto the raised position. Upon filling moat 50, shield 60 may be placed into the lowered position.

It will be apparent to those skilled in the art that many changes and substitutions can be made to the preferred embodiment herein described without departing from the spirit and scope of the present invention.

### LIST OF COMPONENTS

### For Convenience of the Examiner

| | |
|---|---|
| 10 | support |
| 12 | top end |
| 14 | bottom end |
| 20 | shaft |
| 22 | reinforcement |
| 30 | base |
| 40 | platform |
| 42 | attachment holes |
| 50 | moat |
| 52 | liquid |
| 60 | shield |
| 62 | stop |

What is claimed is:

1. A support for holding a load, said support comprising:
a shaft having a base and an opposing platform;
an annular container carried by said shaft between said base and said platform; and
means carried by said shaft between said annular container and said platform for shielding said annular container.

2. The support as recited in claim 1, wherein said shielding means has a lowered position and a raised position and wherein said shielding means covers said annular container when in said lowered position.

3. The support as recited in claim 1, wherein said platform is a flange carried on said shaft.

4. The support as recited in claim 1, wherein said base is tapered.

5. T he support as recited in claim 1, further comprising an insecticide in said annular container.

6. The support as recited in claim 1, wherein said shaft is hollow and further comprising means carried within said hollow shaft for reinforcing said shaft.

7. A support for holding a load, said support comprising:
a shaft having a base;
a platform carried by said shaft;
an annular container carried by said shaft between said base and said platform; and
a shield carried by said shaft between said annular container and said platform, said shield having a raised position and a lowered position.

8. The support as recited in claim 7, wherein said platform is a flange having means for attachment to said load.

9. The support as recited in claim 7, wherein said base is tapered in order to facilitate insertion into the ground.

10. The support as recited in claim 7, further comprising insecticide in said annular container.

11. The support as recited in claim 7, wherein said shaft is hollow and further comprising means carried within said hollow shaft for reinforcing said shaft.

12. A support for holding a load, said support comprising:
a hollow shaft having a tapered base;
a platform carried by said shaft;
an annular container carried by said shaft between said base and said platform;
a shield carried by said shaft between said annular container and said platform for shielding said annular container, said shield having a raised position and a lowered position, said shield covering said annular container when in said lowered position; and
an insect-killing substance in said annular container.

13. The support as recited in claim 12, wherein said shaft is made of plastic and filled with cement.

14. The support as recited in claim 12, wherein said insect-killing substance is insecticide.
